(19) United States
(12) Patent Application Publication
(10) Pub. No.: US 2011/0134482 A1
(43) Pub. Date: Jun. 9, 2011

(54) PRINTER FOR A CASH REGISTER SYSTEM

(75) Inventors: Guenter Baitz, Berlin (DE); Stefan Hoffmann, Berlin (DE); Uwe Kirschke, Berlin (DE); Wolfgang Malke, Berlin (DE)

(73) Assignee: WINCOR NIXDORF INTERNATIONAL GMBH, Paderborn (DE)

(21) Appl. No.: 13/057,565

(22) PCT Filed: Aug. 6, 2009
(86) PCT No.: PCT/EP2009/005682

§ 371 Date: Feb. 4, 2011

(30) Foreign Application Priority Data
Aug. 19, 2008 (DE) 10 2008 038 329.5

(51) Int. Cl. G06F 15/00

(52) U.S. Cl. 358/1.15

(57) ABSTRACT

The invention relates to a printer for a cash register system that has a computer which has a plurality of interfaces to connect to a cash drawer, a keyboard, a customer display, an operator display, a scanner and/or a monitor as well as a network interface, wherein the printer has a printer housing in which a printer control unit and a printer mechanism are located, and wherein the computer and the printer can be provided with electrical voltage over a power supply unit, wherein the computer is configured as a mini-computer with an extremely small housing with compact dimensions, that the mini-computer is integrated into the printer housing on the one hand and that the mini-computer and the printer can be provided with electrical voltage over a common power supply unit.

### CROSS-REFERENCE TO RELATED APPLICATIONS

This application is a National Stage of International Application No. PCT/EP2009/005682, filed Aug, 6, 2009. This application claims the benefit and priority of German application 10 2008 038 329.5 filed Aug. 19, 2008. The entire disclosures of the above applications are incorporated herein by reference.

### BACKGROUND

This section provides background information related to the present disclosure which is not necessarily prior art.

### TECHNICAL FIELD

The invention relates to a printer for a cash register system having a computer which has available to it through a plurality of interfaces a connection to a cash drawer, a keyboard, a customer display, an operator display, a scanner and/or a monitor as well as a network interface, wherein the printer has a printer housing in which a printer control unit and a printer mechanism are located, and wherein the computer and the printer can be supplied with electrical voltage by means of a power supply unit.

### DISCUSSION

Cash register systems, for example the cash register system marketed by the applicant under the trade name “Beetle,” are known for use in department stores, specialty food stores and the like that have a computer based on proven PC-technology. The computer has a housing that is very similar to that of a desktop computer. The housing is preferably located on the sales counter or the work surface of the cash register work station and can function as the standing surface for a flat-screen monitor functioning as an operator display. A plurality of peripheral devices, for example, scanner, printer, customer display, cash drawer or similar are connected to the cash register system computer via a plurality of standardized and/or retail-specific interfaces. Individual peripheral devices, such as a hand scanner, are typically supplied with electrical current over the interface. Other peripheral devices, the printer for example, have their own power connection with a separate power supply unit. The size of the cash register system is particularly disadvantageous. The available counter space should preferably be used for the sale of articles rather than for setting up a cash register system. Furthermore, the wiring for the computer and the peripheral devices and the provision of separate power supply units is complicated and expensive.

### SUMMARY OF THE INVENTION

It is the object of the present invention to develop a cash register system in such a way that the space required for setting up said cash register system is reduced and the expense for wiring the computer to the peripheral devices and the energy supply drops.

The preferred embodiment of the invention is characterized in that the computer is configured as a mini-computer with such a compactly constructed, extremely small housing that, on the one the hand, the mini-computer is integrated into the printer housing and, on the other, the mini-computer and the printer can be provided with electrical voltage over a common power supply unit.

The particular advantage of the invention lies in the fact that by integrating the mini-computer into the printer housing, a printer is created with an integral computer and the usual interfaces to connect keyboard, customer display, operator display, scanner, cash drawer, monitor and the like. Integration into the market network is possible over an integral network interface. In comparison with the conventional cash register systems known from the prior art, the footprint required is considerably smaller, so that more space remains for the display of articles. At the same time, modern mini-computers have a reduced power draw compared with conventional computers. As a result, there is no need for active cooling, using fans for example, resulting in a very quiet and low-maintenance cash register system. Since the power supply unit for the printer also provides the mini-computer with energy, no additional computer power supply unit is necessary. Cost benefits accrue compared with the known solution by eliminating a second power supply unit, integrating micro-computer and printer into only one housing, and dispensing with, typically, two connecting cables between printer and computer.

In accordance with a preferred embodiment of the invention, the common power supply unit for printer and mini-computer is arranged outside the printer housing. The waste heat typical of power supply units builds up outside the printer housing so that the thermal load on the mini-computer is further reduced and, here too, active cooling by means of a fan can be eliminated. Dispensing with the fan further promotes very quiet operation and reduces the cost of maintenance.

In accordance with a further development of the invention, the extremely small housing for the mini-computer is arranged adjacent the printer control unit. Mini-computer and printer control unit can thus be connected to each other over a very short cable. Compared with the connection customarily used today employing two cables, a weight savings and a reduction in cost can be achieved.

In accordance with a further development of the invention, the printer control unit takes over printer emulation, character preparation and/or diagnosis. The printer control unit is connected to the mini-computer over a USB interface and possesses at least one microprocessor, a rewritable read-only memory, a working memory and/or a motor control unit. The printer control unit is thus more or less structurally identical with printer control units in use today in conventional cash register systems. As a result, it is possible to combine printer and computer in a very simple fashion since functional integration, for example transmitting tasks from the printer control unit to the mini-computer, is eliminated. The purely spatial integration and the use of proven components reduce the risk of malfunctions and system breakdowns.

In accordance with a preferred embodiment of the invention, the printer control unit comprises only a programmable integrated circuit for rapid signal processing of signals sent to the printer mechanism (printing device) and signals received from said printer mechanism. In addition, the printer control unit is connected over a data link to the chip set in the mini-computer using the PCI Express expansion standard. The programmable integrated circuit, which can be implemented as a Field Programmable Gate Array (FPGA), assumes the time-critical actuation of motors, thermal line printer and/or print head. Printer emulation, character preparation and diagnosis, however, are implemented in the mini-computer. As a result, additional costs can be saved, particularly for the printer control unit.

Additional advantages become clear from the further dependent claims.

### BRIEF DESCRIPTION OF THE DRAWINGS

Embodiments of the invention are explained in more detail in what follows using the drawings.

The drawings described herein are for illustrative purposes only of selected embodiments and not all possible implementations, and are not intended to limit the scope of the present disclosure.

FIG. 1 shows a schematic representation of a printer for a cash register system in accordance with a first embodiment and

FIG. 2 shows a schematic representation of a printer for a cash register system in accordance with a second embodiment.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

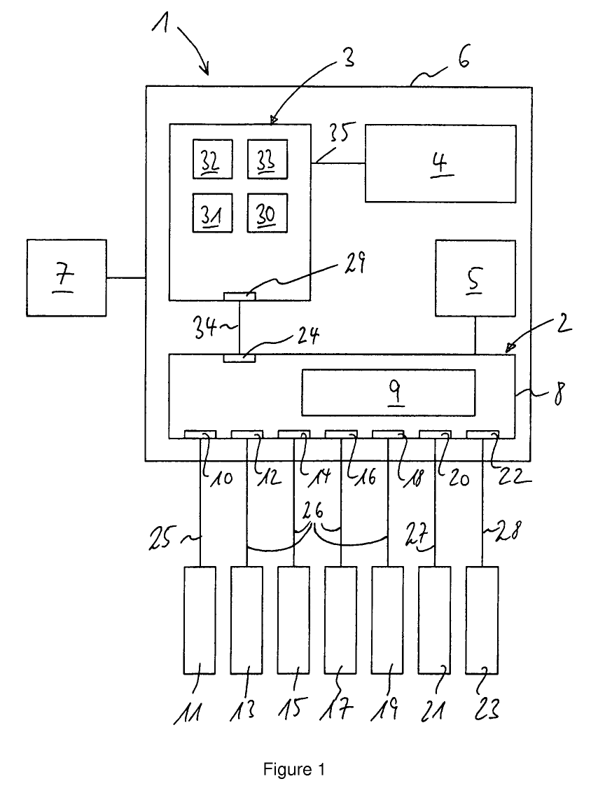

The printer 1 for a cash register system from FIG. 1 consists essentially of these components: mini-computer 2, printer control unit 3, printer mechanism 4 and memory 5. The components are arranged in a common housing 6 and are provided with electrical voltage over a common power supply unit 7 which is located outside the printer housing 6.

The mini-computer possesses a very small housing 8 of compact size which contains a chip set 9 and an interface 10 to connect to the cash drawer 11, an interface 12 to connect to a keyboard 13, an interface 14 to connect to a customer display 15, an interface 16 to connect to an operator display 17, an interface 18 to connect to a scanner 19, an interface 20 to connect to a monitor 21, and an interface 22 to connect the mini-computer 2 to a network 23. The mini-computer further comprises an interface 24 to connect to the printer control unit 3.

Depending on the type of peripheral device, the interface can meet a customary standard (USB, RS232, VGA) or be configured to be retail-specific. Thus, the cash drawer 11 is connected to the mini-computer using a retail-specific data line 25. The keyboard 13, the customer display 15, the operator display 17 and the scanner are connected to the mini-computer over a USB cable 26. The monitor 21 is connected to the mini-computer over a data link 27 that uses the DVI or VGA standard. The connection between the mini-computer and the network 23 is made over a LAN cable 28. The various peripheral devices can have their own power supply unit (not shown) or be supplied with electrical voltage over the data line.

In accordance with an alternative embodiment of the invention not shown here, the peripheral devices can be connected to the mini-computer 2 over a connection standard other than the one shown in FIG. 1. For example, the mini-computer 2 can communicate wirelessly with the network 23 using a WLAN connection. It is likewise possible to connect additional peripheral devices, for example a hand scanner, to the mini-computer 2. Unused, additional interfaces not shown in the configuration from FIG. 1 can serve this purpose.

A memory 5 is also assigned to the mini-computer 2. The memory 5 can be configured as a hard disk drive (HDD) or as a solid state drive (SDD).

The printer control unit 3 possesses an interface 29 to connect to the microcomputer 2, a microprocessor 30, a rewritable read-only memory 31, a working memory 32 and a motor control unit 33. The interface 29 is configured here, for example, as a USB interface 29 so that the printer control unit 3 is connected to the mini-computer 2 over a USB cable 34. The USB cable 34 can be kept short to realize a compact structure and to reduce weight and cost. To achieve this, the interface 29 for the printer control unit 3 and the interface 24 of the mini-computer 2 are arranged facing one another.

The printer control unit 3 is connected to the print device 4 over a data line 35. The print device 4 comprises, among other things, actuators and sensors (not shown), the paper feed and advance, the print head, and a thermal line printer.

In the present configuration, the mini-computer 2 is assigned the same function that a standard PC performs in the cash register systems known from the prior art. It serves to drive the various peripheral devices, to identify the scanned items, and to determine the sales price and the like. The mini-computer 2 further communicates with the printer control unit 3 in such a way as to trigger the print request and it provides the information to be printed.

The mini-computer 2 possesses an extremely small housing that is also known by the technical name Small Form Factor, or SFF housing. The chip set 9 for the mini-computer 2 is especially energy-saving and, vis-à-vis comparable single-core processors, has a power consumption which is lower by a factor of about 10. As a result of this clearly lower power consumption of the chip set 9, active cooling, for example by means of a fan, can be eliminated. As a result, the mini-computer 2 operates very quietly and is designed to be low-maintenance.

The printer control unit 3 receives the print order from the mini-computer 2. The control unit takes over printer emulation, character preparation, fonts, diagnosis and the like, and drives the actuators for the printer mechanism. The printer control unit further receives the signals that are provided by the sensors, buffers them if necessary, and processes them further. The microprocessor 30 (Master Control Unit MCU), the rewritable read-only memory (Flash) 31, the working memory 32 (RAM), and the motor control unit 33 are provided for this purpose.

The mini-computer 2, the printer control unit 3 and the memory 5 can be attached on a common carrier, configured as a carrier plate (not shown). The printer control unit 3 and the mini-computer 2 can furthermore be arranged adjacent such that the interface 24 assigned to the mini-computer 2 to connect to the printer control unit 3 and the interface 29 assigned to the printer control unit 3 to connect to the mini-computer 2 face one another. This allows for a very compact construction and efficient wiring of these components. The carrier plate does not have to be executed as a separate component. It can be part of the printer housing 6.

The power supply unit 7 provides the components arranged in the printer housing 6—mini-computer 2, printer control unit 3, printer mechanism 4, and memory 5—with energy. The power supply unit 7 itself is arranged outside the printer housing 6. The resulting waste heat does not accumulate inside the printer housing 6 and can be easily dissipated. The power supply unit 7 is connected through a power cable (not shown) to a power grid (also not shown).

As a result of locating the power supply unit 7 outside the printer housing 6 and of eliminating active cooling of the chip set 9, a very quiet and low-maintenance cash register system can be realized. As a result of the low power draw of the chip set 9, the energy consumption of the cash register system is substantially reduced. Operating economy and ecological benefits result.

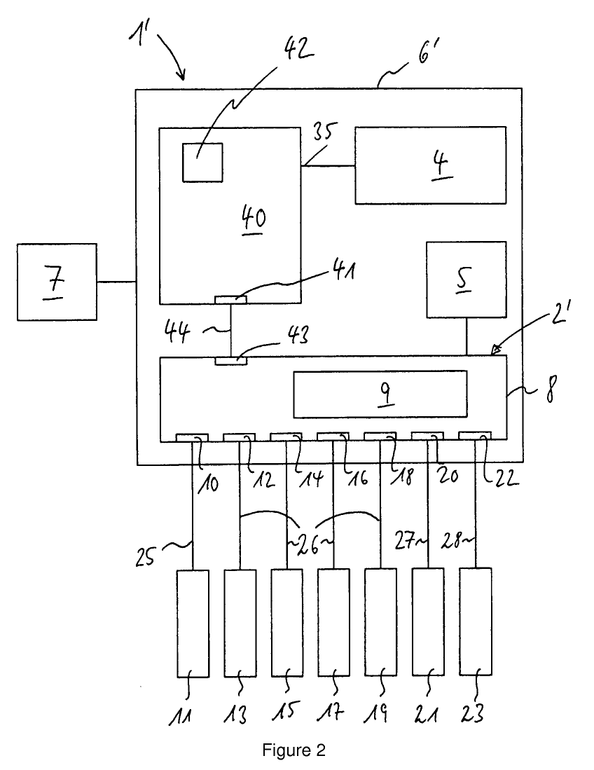

In accordance with an alternative embodiment of the invention from FIG. 2, the printer 1′ has a printer control unit 40 located in a printer housing 6′ that has an interface 41 to connect the printer control unit 40 to a mini-computer 2′, and a programmable integrated circuit 42. The programmable integrated circuit can be configured here, for example, as a Field-Programmable Gate Array (FPGA).

Mini-computer 2′ has an interface 43 to connect to the printer control unit 40. For the rest, the construction of said mini-computer 2′ resembles that of mini-computer 2 from embodiment 1. The same reference numerals describe identical components and component function.

The printer control unit 40 and mini-computer 2′ are linked to each other by a data line using the PCI Express expansion standard (PCI: Peripheral Component Interconnect).

In the second embodiment, mini-computer 2′ assumes activation of the printer mechanism 4. In place of microprocessor 30, rewriteable read-only memory 31, working memory 32 and motor control unit 33, printer control unit 40 has only a programmable logic 42 that is configured as an FPGA. The FPGA assumes the time-critical actuation of motors, thermal line printer and/or print head. However, printer emulation, character preparation, fonts, diagnostic function and the like are realized centrally in the mini-computer 2′. The connection 44 using PCI Express represents an expansion standard that serves to actuate peripheral devices using chip set 9 in mini-computer 2′.

The printer control unit 40, by dispensing with microprocessor 30, memory 31, 32 and motor control unit 33, can be produced extremely cost-effectively. At the same time, through extensive functional integration of mini-computer 2′ and printer control unit 40, an especially compact form of printer 1′ can be implemented. Overall, the printer housing 6′ can be built especially compactly so that an extremely small footprint can be realized compared with conventional cash register systems.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A printer for a cash register system that has a computer which has a plurality of interfaces to connect to a cash drawer, a keyboard, a customer display, an operator display, a scanner and/or a monitor and a network interface, wherein the printer has a printer housing in which a printer control unit and a printer mechanism are arranged, and wherein the computer and the printer can be provided with electrical voltage via a power supply unit, comprising wherein the computer is configured as a mini-computer with a small housing, in that the mini-computer is integrated into the printer housing, and in that the mini-computer and the printer are provided with electrical voltage over a common power supply unit.

2. The printer from claim 1, wherein the power supply unit is arranged outside the printer housing.

3. The printer from claim 1, wherein a memory assigned to the mini-computer is arranged outside the small housing and inside the printer housing.

4. The printer from claim 1, wherein the small housing is arranged adjacent the printer control unit.

5. The printer from claim 1, wherein a common carrier is provided to mechanically anchor the printer control unit, the small housing and/or the memory.

6. The printer from claim 5, wherein the common carrier is formed by the printer housing.

7. The printer from claim 1, wherein the interface assigned to the mini-computer to connect the printer control unit to the mini-computer is located on the side of the small housing facing the printer control unit and/or the interface assigned to the printer control unit to connect the printer control unit to the mini-computer is located on the side of the printer control unit facing the small housing.

8. The printer from claim 1, wherein a printer control unit carrying out printer emulation, character preparation and/or diagnosis is connected to the mini-computer over a USB interface and has a microprocessor, a rewriteable read-only memory, a working memory and/or a motor control unit.

9. The printer from claim 1, wherein the printer control unit has one programmable integrated circuit for rapid signal processing of signals sent to the printer mechanism or received from said printer mechanism.

10. The printer from claim 9, wherein the printer control unit is connected to the mini-computer that carries out printer emulation, character preparation and/or diagnosis over a data line using the PCI Express expansion standard.
